(19) United States
(12) Patent Application Publication
(10) Pub. No.: US 2020/0196795 A1
(43) Pub. Date: Jun. 25, 2020

(54) DOUBLE-COVER ELECTRICAL GASTRONOMY GRILL

(71) Applicant: Dariusz Wadolowski, Pisz (PL)

(72) Inventor: Dariusz Wadolowski, Pisz (PL)

(21) Appl. No.: 16/723,831

(22) Filed: Dec. 20, 2019

Related U.S. Application Data
(63) Continuation of application No. PCT/PL2018/000062, filed on Jun. 19, 2018.

(30) Foreign Application Priority Data
Jun. 20, 2017 (PL) P.421959

(51) Int. Cl. A47J 37/06; F24C 7/08

(52) U.S. Cl. CPC A47J 37/0611; F24C 7/067; F24C 7/082

(57) ABSTRACT

The double-cover electrical gastronomy grill, having a rectangular main casing, a socket for connecting electric current, in the rear of which two separate top covers are spring mounted side by side, and inside the main casing and in the upper covers heating plates are mounted, with the upper covers being equipped with pressure elements and heat insulating handles, the front wall of the main casing comprises a control panel equipped with a temperature controller, a time indicator and operating indicator, wherein each of the upper heating plates and in the bottom heating plate, in the area of effect of each of the upper heating plates, patron heaters are embedded.

### CROSS REFERENCE TO RELATED APPLICATIONS

This application is a continuation under 35 U.S.C. § 120 of International Application PCT/PL2018/000062, filed Jun. 19, 2018, which claims priority to Polish Application No. P. 421959, filed Jun. 20, 2017, the contents of each of which are incorporated by reference herein.

### FIELD OF THE INVENTION

This disclosure relates to a double-cover electric gastronomy grill for the purposes of small catering.

### BACKGROUND

Double-cover electric toasters are generally known for home and small gastronomy usage which are equipped with heating plates with heating pipes. Dividing the heating surface into two parts enables the possibility of grilling one serving of food without the need of using the entire heating surface of the device. However, when using both upper covers heating surfaces types of food have to have a similar preparation time. Grilling products of different sizes, thus requiring different preparation times, requires manual, often intuitive, time selection, due to the fact that only one time setting can be set for the entire device. Specific conditions of services of small gastronomy can be observed, for example, at gas stations where one employee is required to perform many tasks and, additionally, fulfill various client orders regarding sizes of the hot meals ordered, such as sandwiches or buns. In such situations, a diversified grilling time is required. Additionally, in the case of a single-employee service greater emphasis should be put on the safety requirements, the explicitness of the indication of the catering service having been finished, and the ease of use.

Much significance is also attributed to the efficiency and reliability of the equipment. In the case of a heat pipe malefaction the known toasters are repaired outside station, which requires having a replacement grill, or suspension of catering services until the repairs are finished.

The double-cover electric gastronomy grill, having a cuboid main casing fitted with a socket for connecting electric current, to which at the rear side two separate upper covers are spring mounted side by side, and inside the upper casing and in the upper covers, the lower and upper heating plates are mounted, with the upper covers being equipped with pressure elements and heat-insulating handles, while the front wall of the main casing includes a control panel equipped with a temperature regulator, a time indicator and an operating indicator characterized in that, according to the disclosure, that each upper heating plate is equipped with patron heaters, and the lower heating plate is equipped with patron heaters in area of effect of each upper heating plates. The upper cover handles are fitted with LEDs connected to the temperature controller. The control panel is equipped with two time indicators, separate for each area of effect of the upper heating plates.

Thanks to the use of patron heaters it is possible to set separate working times for both heating fields, and in the case of one being burnt, to perform a quick replacement, which can be done on site. In such cases the suspension of the catering services lasts only for the duration of the replacement of the heater. The installation of LEDs in the handles of the upper covers, connected to the temperature controllers, enables quick recognition of a progress of the process and improves the operational safety by improving visibility of the indicator.

### BRIEF DESCRIPTION OF THE DRAWINGS

FIG. 1 shows the open grill in perspective view from the front.

FIG. 2 shows the open grill in perspective view from the bottom.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

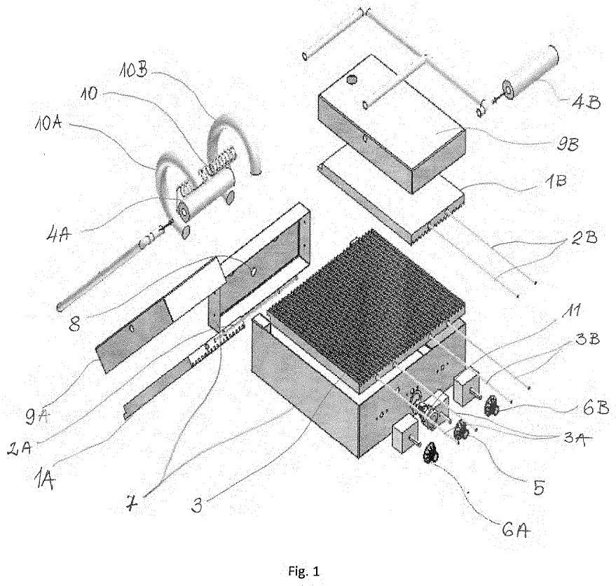

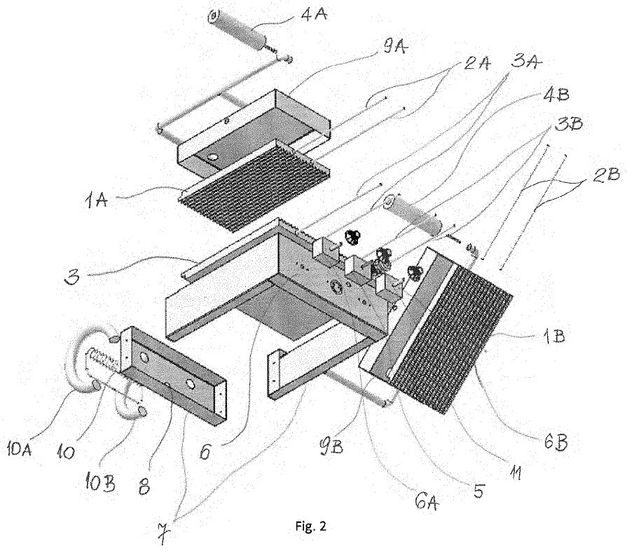

The invention is explained in greater details in the exemplary embodiment displayed in the drawing of FIG. 1, which shows the open grill in perspective view from the front, and in the drawing of FIG. 2, which shows the open grill in perspective view from the bottom.

The double-cover electrical gastronomy grill has a cuboid main casing 7 made of stainless steel. In the rear wall of the main casing 7 there is an electrical connection socket 8 made, and by means of springs 10A, 10B two separate upper covers 9A, 9B are attached side by side. Inside the main casing 7 and in the upper covers 9A, 9B, the following heating plates are mounted: lower 3 and upper 1A, 1B. The top covers 9A, 9B are equipped with a spring-loaded pressure element 10 and heat-insulating handles 4A, 4B. The front wall of the main casing 7 includes a control panel 6 which is equipped with a temperature controller 5, an operating indicator 11 and two time indicators 6A, 6B, separate for each area of effect of the upper heating plates 1A, 1B. In each of the upper heating plates 1A, 1B there are embedded two heaters 2A, 2B. In the lower heating plate 3, two patron heaters 3A, 3B are embedded in the area of effect of each of the upper heating plates 1A, 1B. In the handles 4A, 4B of the upper covers 1A, 1B, are mounted LEDs connected to the temperature controller 5.

After placing the products to be grilled on the bottom heating plate, the products are pressed with the top covers. Using the time indicators the grilling time is set separately for each of the products. The passage of time is indicated by the change of the color of the LED mounted in the handle.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A double-cover electrical gastronomy grill comprising:
a cuboid main casing, the main casing having a socket for connecting electric current, to which the rear of two separate top covers are spring mounted side by side;
wherein
inside the main casing of which and to the upper covers of which heating plates are mounted, the lower and upper, wherein
the top covers are equipped with pressure elements and heat insulating handles; wherein
in each of the upper heating plates a patron heater is fitted, and in the bottom heating plate, in the area of effect of each of the upper heating plates, patron heaters are fitted;
a front wall of the cuboid main casing having a control panel equipped with a temperature controller, a time indicator and an operating indicator; and
LEDs attached to the handles mounted to the top covers and connected to the temperature controller, and the control panel equipped with two time indicators, separate for each area of effect of the upper heating plates.
